(19) United States
(12) Patent Application Publication
(10) Pub. No.: US 2003/0194240 A1
(43) Pub. Date: Oct. 16, 2003

(54) Jitter compensation method and apparatus

(76) Inventors: Linn Frederick Mollenauer, Colts Neck, NJ (US); Chunhui Xu, Ithaca, NY (US)

Correspondence Address: Docket Administrator (Room 3J-219), Lucent Technologies Inc., 101 Crawfords Corner Road, Holmdel, NJ, 07733-3030, US

(21) Appl. No.: 10/305,855

(22) Filed: Nov. 27, 2002

Related U.S. Application Data
(60) Provisional application No. 60/371,351, filed on Apr. 10, 2002.

(51) Int. Cl. H04B 10/00

(52) U.S. Cl. 398/158; 398/155

(57) ABSTRACT

A jitter compensator apparatus is provided having a phase modulator for receiving jittered pulses and a clock recovery device for locally recovering a clock signal. The phase modulator is driven in synchronism by the the locally recovered clock signal and is adapted to provide a frequency shift to the jittered pulses proportional to the jitter displacement of each of the jittered pulses.

### CROSS REFERENCE TO RELATED APPLICATIONS

This application claims priority of Provisional Application Serial No. 60/371351 which was filed Apr. 10, 2002.

### FIELD OF THE INVENTION

This invention relates generally to the field of optical communications, and in particular to a method and apparatus for improving optical transmission performance by reducing non-linear penalties resulting from cross phase modulation in ultra-long-haul wavelength-division multiplex optical transmission systems.

### BACKGROUND OF THE INVENTION

In the absence of significant non-linear penalties, and when noise-induced timing jitter (the Gordon-Haus effect) is small, the maximum distance for error-free, ultra-long-haul (ULH) transmission tends to be limited by amplified spontaneous emission (ASE) noise-induced amplitude jitter. In that case, the maximum transmission distances can be large. Consider, for example, a terrestrial system where the additional loss from dispersion compensating fiber (DCF) modules, wavelength-division multiplexing (WDM) couplers, isolators, splices, etc., yields an effective loss rate (total loss/transmission distance) of ˜0.28 dB/km, where the use of Raman gain yields a combined excess spontaneous emission and noise-penalty factor of ˜2 dB, where the penalty from Rayleigh double-back-scattering of the signal or so called MPI (multi-path interference) is negligibly small, and where, finally, the path-average signal pulse energy is ˜25 fJ (a typical value for dispersion-managed systems). Then for a S/N ratio (signal pulse to noise equipartition energy ratio) of ˜120, for which the bit error rate (BER) is in principle <1×10⁻¹², the corresponding distance is ˜16,000 km. Although such “error-free” distances have been achieved in laboratory experiments involving a single channel, in real-world, dense WDM systems, the maximum achieved error-free distances tend to be considerably less than half that value (˜6000 km at 10 Gbit/s per channel). Thus, nonlinear penalties tend to provide the dominant limitation in dense WDM transmission.

Nevertheless, for dense WDM with dispersion-managed solitons, and where, additionally, the maximum pulse width is no more than about half a bit period, the only significant nonlinear penalty results from XPM (cross phase modulation) during collisions with pulses of other channels. Because of the limited pulse breathing, intra-channel four wave mixing and XPM both tend to be negligibly small, growth of inter-channel four wave mixing tends to be defeated by the large phase mismatch created by the large local dispersion, and SPM (self-phase-modulation), vital to maintenance of the solitons, is beneficial. The inter-channel collisions result in a nearly pure jitter in pulse arrival times. Without removal of the jitter, the electrical eye pattern of a WDM channel tends to suffer severely penalizing closure, which in turn accounts for the reduction in transmission distances cited above.

An important fact about the nonlinear timing jitter is that its statistical distribution tends to be strongly bounded. There are two reasons for this bounded distribution: first, the collisional XPM tends to fall off as the inverse square of the channel separation, such that the major damage is done by the immediately adjacent channels, and second, the maximum possible number of collisions with those adjacent channels is small. (For an adjacent channel spacing of 50 GHz, and a path-average dispersion parameter of 0.15 ps/nm-km, the minimum spacing between successive collisions is ˜1700 km.)

In a real system with ASE noise, Gordon-Haus jitter (which has a Gaussian distribution) adds to the nonlinear jitter. In dispersion-managed soliton systems, however, the Gordon-Haus jitter tends to be small. It has been shown that the probability that the net jitter will be greater than ±⅓ bit period is less than 1×10⁻⁹ up to distances of at least 8,000 km. This fact is important to the present scheme for overcoming the penalty from timing jitter.

Accordingly, it would be greatly beneficial to provide a device to effectively eliminate non-linear penalties resulting from XPM in WDM optical transmission systems.

### SUMMARY OF THE INVENTION

A jitter compensator apparatus is provided having a phase modulator for receiving jittered pulses and a clock recovery device for locally recovering a clock signal. The phase modulator is driven in synchronism by the the locally recovered clock signal and is adapted to provide a frequency shift to the jittered pulses proportional to the jitter displacement of each of the jittered pulses.

### BRIEF DESCRIPTION OF THE DRAWING

The following detailed description of preferred embodiments of the present invention will be better understood when read in conjunction with the appended drawing. For the purpose of illustrating the present invention, there are shown the drawing embodiment which is presently preferred. However, the present invention is not limited to the precise arrangements and instrumentality shown. In the drawing:

FIG. 1 is a schematic diagram of one embodiment of the apparatus of the present invention;

FIG. 2 is the plot showing temporal details of one mode of operation of an embodiment of the present invention;

FIG. 3 is a schematic diagram of one embodiment of apparatus for adding second harmonic to the drive for the phase modulator;

FIG. 4 is a plot showing the frequency shift as a function of time in accordance with one embodiment of the invention;

FIG. 5 is a plot showing the extension of a jittered pulse into an adjacent bit period;

FIG. 6 is a block diagram of one embodiment of a pulse compressor according to the invention;

FIGS. 7a-h summarize the results of a numerical study of one embodiment of the present invention;

FIG. 8 is a block diagram of another embodiment of the present invention;

FIG. 9 is a block diagram of another embodiment of the present invention;

FIGS. 10a-b are plots showing the performance from a numerical simulation of an ultra-long haul dense WDM transmission system;

FIGS. 11a-b show eye diagrams of one channel of a dense WDM transmission system,

FIG. 12 is a plot showing the bit error rate versus distance with and without jitter compensation; and

FIG. 13 is a block diagram of another preferred embodiment of the present invention.

### DETAILED DESCRIPTION PREFERRED EMBODIMENTS

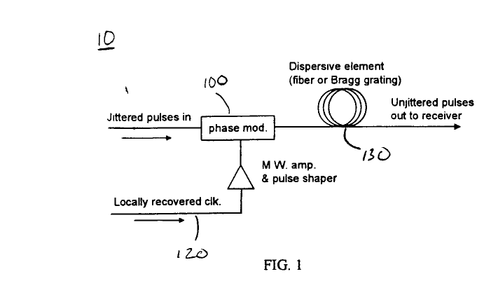

A schematic diagram of one embodiment of the apparatus 10 of the present invention is shown in FIG. 1. The apparatus 10 comprises a phase modulator 100, appropriately driven in synchronism with a locally recovered clock signal 120, and followed by a dispersive element 130. The clock signal 120 is derived from a detector and other electronic devices to produce an electrical signal, periodic at the bit-rate, and with very stable phase with respect to the mean optical pulse arrival time. The apparatus is preferably employed in an optical transmission system just prior to a receiver (not shown). The dispersive element 300 is preferably an essentially linear dispersive element, such as a coil of fiber or a fiber Bragg grating.

The phase modulator 100 is designed to give each incoming pulse a frequency shift proportional to its jitter displacement. The dispersive element 130 then serves to translate, or “focus” each incoming pulse onto the mean arrival time (modulo the bit period). Hence, the apparatus 10 can be referred to as a “temporal lens”. To the extent that the temporal lens apparatus 10 translates or focuses the incoming pulses, the temporal lens apparatus 10 removes the closure of the eye pattern, and hence there is no longer a non-linear penalty.

Preferably, the recovery of the clock signal 200 is performed before the phase modulator 100. More preferably, the apparatus 10 incorporates an independent clock to avoid any possible problems of varying delay with temperature being the dispersive element 130.

It can be understood by one of ordinary skill in the art that a plurality of temporal lens devices according to the present invention may be employed in a WDM optical transmission system to eliminate non-linear penalties from a plurality of channels of a WDM signal.

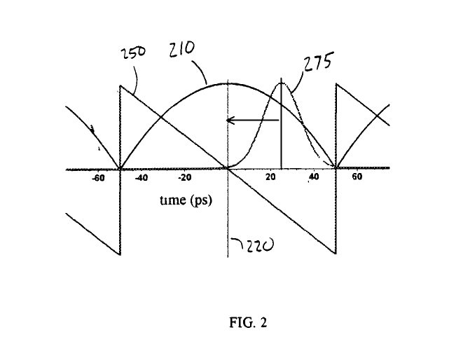

In operation, the phase shift, φ(t), produced by the modulator 100 is a series of truncated parabolas 210, centered about the middle of each bit period 220, such that the corresponding frequency shift (the time derivative of φ(t)) is directly proportional to time as measured from the center of each period (see FIG. 2). The saw-toothed curve 250 is the resultant frequency shift induced on incoming jittered pulses. The pulse 275, which has arrive 25 ps late, will be shifted to the center of the period by the temporal lens apparatus 10.

A mathematical analysis of the present invention is as follows:

We write the (Gaussian) signal pulses in the form:

u(t)=u₀exp{−½(η+iβ)(t−δt)²}

where η=τ₀⁻² (the intensity FWHM, τ=\sqrt{4 ln 2}τ₀), where β is the chirp parameter, and where δt is the displacement of the center of the pulse from t=0. Note also that in the representation used here, the central optical frequency has been factored out.

Before the phase modulator, if we have the unchirped pulse

u(t)=u₁exp{−½η₀(t−δt)²} (1)

then after the modulator (which applies a chirp with parameter β_{mod}), we have:

u(t)=u₂exp{−½η₀(t−δt)²−i(½β_{mod}t²)}, (2)

which can be rewritten as:

u(t)=u′₂exp{−½(η₀+iβ_{mod})(t−δt)²−i(β_{mod}δt)t}. (2a)

Note that although the pulse still has the same width (τ₀), it now has a linear chirp β_{mod} and a shift in mean frequency of δω=−β_{mod}δt.

When the pulse is then put through a linear element of dispersion

Δ=1/β_{mod}, (3)

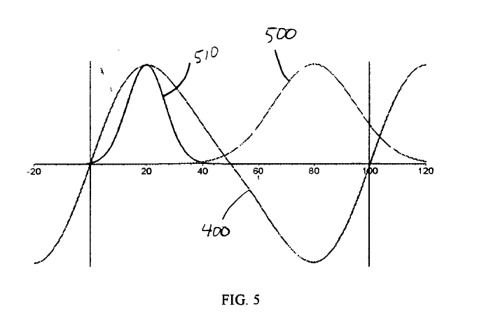

it will then be moved in time by δωΔ=−δt, exactly as needed for focusing on to the center of the bit period. Note that although Δ and β_{mod} have the same algebraic sign, the pair can be either positive or negative. (The curves of FIG. 5 correspond to β_{mod}>0.)

The widths of the pulses emerging from the temporal lens apparatus 10 constitute a second kind of focusing that is also of some concern. Using the ODE (ordinary differential equation) method described elsewhere [5], we know that when the pulses are subject to a linear element of dispersion Δ, the quantity q=(η+iβ_{mod})⁻¹ must obey the equation

q₂=q₁+iΔ (4)

where q₂ and q₁ represent the values after and just before the dispersive element, respectively. From Eqn. (2a), we have q₁=(η₀+iβ_{mod})⁻¹. Thus, combining Eqns. (3) and (4), we have:

$$\frac{1}{{η}_{2} + i {β}_{2}} = \frac{1}{{η}_{0} + i {β}_{mod}} + \frac{i}{{β}_{mod}} \qquad ( 5 )$$

With minor manipulation, Eqn. (5) can be rewritten as:

η₂+iβ₂=β_{mod}²/η₀−iβ_{mod} (5a)

Finally, substituting β_{mod}=gη₀ into Eqn. (5a), we obtain the final pulse width:

τ₂=τ₀/g (6)

It is important to know the peak-to-peak swing in phase, δφₘₐₓ, required from the modulator. Assuming an inital pulse width τ=T/3 (T is the bit period), τ₀=T/(3\sqrt{4 ln 2}). Thus:

$$δ {φ}_{max} = \frac{1}{2} {{β}_{mod} ( T / 2 )}^{2} = ( g / 8 ) {( T / {τ}_{0} )}^{2} = \frac{{( 3 \sqrt{4 ln 2} )}^{2} g}{8} = ( 3.1192 … ) g$$

or nearly π radians at g=1. Note that the required drive is directly proportional to the pulse compression factor g.

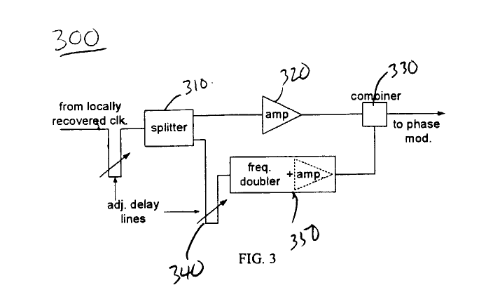

Practical limitations to the frequency response of the phase modulator 100 and its drive electronics may make the ideal operation difficult to achieve, on account of the severe discontinuity in the slope of φ(t) at the phase edges of the bit periods. A pure sinusoid may be employed to drive the modulator 100 when the capture range for displaced pulses is not required to be greater than about ±T/4. For a somewhat bigger capture range, however, an appropriate amount of second harmonic, with the correct phase, may be added to the fundamental sinusoid to drive the phase modulator 100. Apparatus for adding second harmonic to the fundamental sinusoidal drive for the phase modulator 100 is shown in FIG. 3. The apparatus 300 splits the sinusoidal electrical signal from the locally recovered clock signal into two parts using splitter 310. The upper part is amplified using amplifier 320 and sent, through a combiner 330, to the phase modulator. The lower part is first adjusted in phase by an adjustable delay line 340, then frequency doubled and amplified using a frequency doubling and amplifying device 350, before also being sent, through the combiner 330, to the phase modulator.

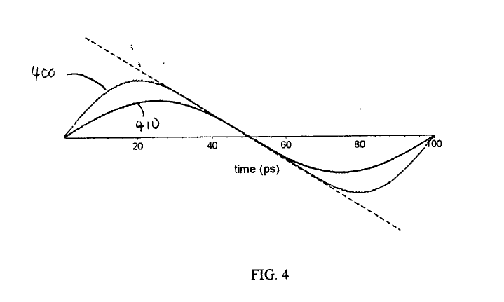

The resultant phase modulator drive then produces frequency shifts of the optical pulses that are directly proportional to their time displacements over a greater range of arrival times, as shown in FIG. 4.

Note that because both the amplitude and the relative phase of the second harmonic can be adjusted independently of the fundamental, defects in the response of the phase modulator 100 to the second harmonic can be perfectly compensated. FIG. 4 shows the resultant frequency shift as a function of time 400 where the drive contains the optimum amount of second harmonic in comparison with that produced by a pure sinusoid 410. The addition of the second harmonic extends the capture range to beyond about ±30% of the bit period.

In most dispersion-managed systems the minimum pulse width is typically about one third the bit period in width. As shown in FIG. 5, a significant fraction of a severely jittered pulse 500 tends to extend well into an adjacent bit period. A narrower pulse 510, however, is contained within its own bit period. (The frequency shift from combined fundamental and second harmonic drive 400 in FIG. 4 is repeated here for convenient reference.) Since that part extending into the adjacent period will be sent in the wrong direction in time by the temporal lens apparatus 10, it will tend to cause inter-symbol interference. Furthermore, less than the full energy of the pulse will be sent in the right direction. Thus, a too-wide input pulse width contributes to eye closure in two ways, by simultaneously acting to lower the peak of the eye and to raise its floor.

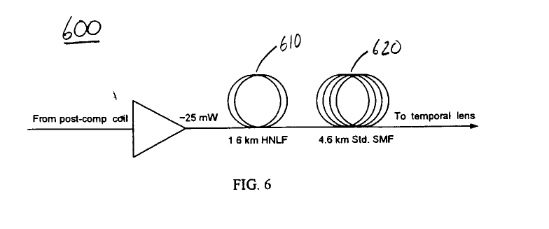

One embodiment of the present invention solves this problem by compressing the pulses before they enter the temporal lens. The compression may be performed by a pulse compressor 600, shown in FIG. 6, which creates self phase modulation (SPM) in a short piece of highly non-linear (HNLF), low dispersion fiber 610, followed by the appropriate amount of anomalous dispersion (which could be supplied either by a length of fiber 620 with D>0, or by a Bragg grating (not shown)). Preferably, compression is provided without at the same time subtracting from the post dispersion compensation.

Experimental test have shown that a compressor 600 may reduce incoming, ˜35 ps FWHM pulses to somewhat less than half that width (˜15 ps) where the HNLF has a core area of approximately of 15 μm² and dispersion parameter D of approximately −6 ps/nm-km. The net linear dispersion (approximately 68 ps/nm-km) was kept small so that it would not significantly reduce the post-dispersion compensation of approximately −300 ps/nm-km.

In general, pre-compression tends to change the required level of modulator drive (∝β_{mod}) The required change is easiest to calculate when the compressed pulse is unchirped, as follows. Let h be the pulse pre-compression factor, and let c be the overall compression factor. (i.e., c=hg.) Simple extension of the mathematical treatment discussed above shows that β_{mod}=hcη₀. Thus, for a given overall compression factor, β_{mod} and the modulator drive voltage to produce it will be increased by the pre-compression factor. The situation becomes more complex when, for practical reasons, the pre-compression is not carried out to the minimum pulse width, so that the compressed pulse still contains a significant negative chirp (as in FIG. 6, for example). That residual chirp will then enhance (diminish) the net magnitude of the chirp of the pulse emerging from the phase modulator 100 when β_{mod} is negative (positive). The compression factor g and the pulse spectral width will be similarly enhanced (diminished). A negative β_{mod} (and hence negative, or anomalous, Δ, for the dispersive element of the temporal lens itself) is preferably chosen to obtain sufficient modulator drive.

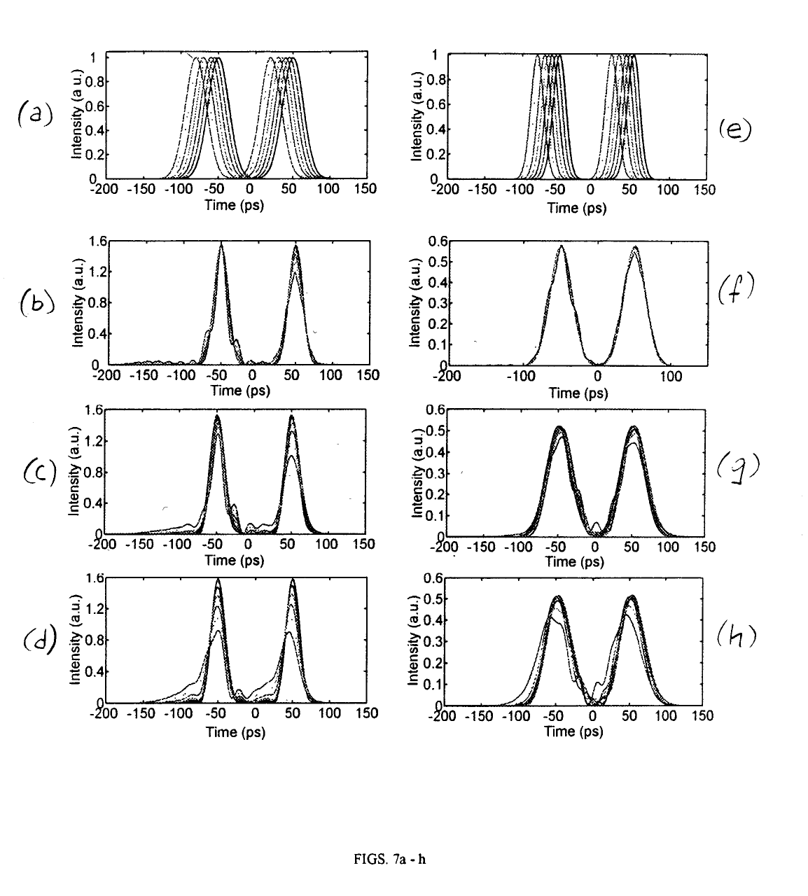

FIGS. 7a-h below summarizes the results of a numerical study of the temporal lens apparatus of one embodiment of the present invention. FIGS. 7a-d show a part of the pulse intensity versus time with unchirped, Gaussian pulses having a width of 33 ps. FIGS. 7e-h show plots of similar unchirped Gaussian pulses having a width of 20 ps. FIGS. 7a and 7e show input pulses, displaced 0 to −30 ps with respect to the center of the bit period, in steps of −5 ps. FIGS. 7b and 7f show the output from the temporal lens apparatus where an ideal parabolic modulator drive was used. FIGS. 7c and 7g show the output from the temporal lens apparatus using a combined fundamental pulse second harmonic drive. FIGS. 7d and 7h show the output from the temporal lens apparatus where a simple sinusoidal drive was used. Severe pulse distortion and resultant intersymbol interference results from the combination of simple sinusoidal drive and the greatest of the initial displacements, especially from the wider input pulses. By contrast, the combination of either of the two drives shown in FIGS. 5 and 6 and the narrower input pulses results in substantially improved eye patterns. Additionally, the narrower input pulses result in wider pulses at the temporal lens output.

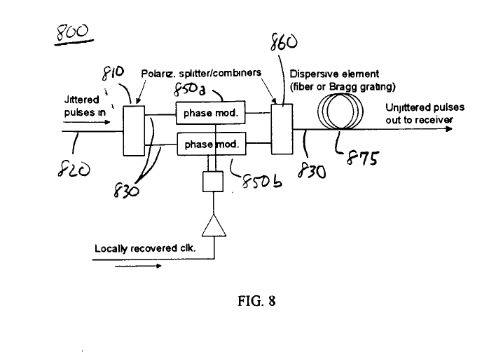

In another preferred embodiment of the present invention, shown in FIG. 8, a polarization independent temporal lens 800 is provided. A first polarization splitter 810 separates the input of arbitrary polarization into its two, orthogonal, linearly polarized components. Each of those components is then sent through a phase modulator 850a-b. The outputs of the two phase modulators 850a-b are then combined by a second polarization combiner 860 before being sent on to a dispersive fiber element 875. The input and output (polarization-maintaining) fiber leads 820 and 825 as well as the coaxial cables to the modulators 830 preferably constitute three pairs matched in length. In a more preferred embodiment, both phase modulators 850a-b are mounted on a single chip, and the polarization splitter/combiners 800, 860 are directly coupled to that chip, so that all elements could be mounted in a single package.

In another alternative embodiment (not shown) two x-cut phase modulators are placed in series with a half-wave plate sandwiched between them. The elements are preferably mounted in a single package. In this embodiment, the polarization splitter/combiners are no longer needed.

When the phase modulator drive according to the invention is correctly synchronized with the mean pulse arrival time, the optical spectrum of the pulse train after the modulator is symmetrical about the original spectral position, but when the drive is late or early, the spectrum is strongly skewed to the low or high frequency side of the original spectral center.

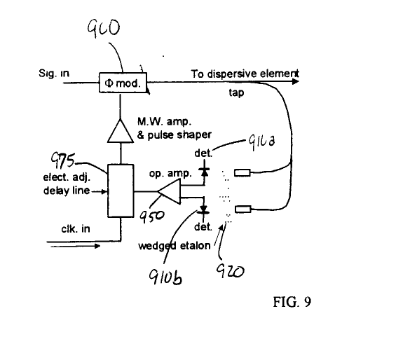

An embodiment of the present invention which provides for automatic adjustment of the drive phase is shown in FIG. 9. High and low frequency components of the outpuut spectrum of the modulator 900 are provided to two detectors 910a, 910b, by virtue of a tuned wedge etalon filter 920. A low frequency operational amplifier 950 then converts the difference between two detector outputs into an error signal to control the electrically adjustable delay line 975. Preferably, the free spectral range of the wedged etalon 920 is set equal to the chanel spacing in a dense WDM system such that one set of parameters of the wedged etalon 920 may be used for all channels.

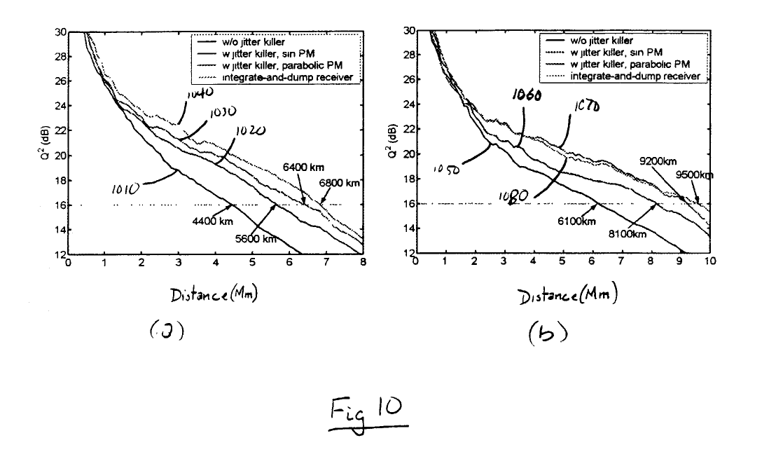

The performance from a numerical simulation of an ultra-long-haul dense WDM transmission system using 100 km spans of TWRS fiber, backward Raman pumped every 50 km, and compensated with Raman-pumped DCF every 100 km for a path-average dispersion parameter of 0.15 ps/nm-km is shown in FIG. 10. The numerical simulations involve eight channels at 10 Gbit/s each and adjacent channel separations of 50 GHz. FIG. 10a shows system performance with all channels co-polarized. FIG. 10b shows system performance with adjacent channels orthogonally polarized. Traces 1010 and 1050 show the BER without jitter compensation. Traces 1020 and 1060 show the BER with jitter compensation and a sinusoidal phase modulator drive. Traces 1030 and 1070 show the BER with jitter compensation and a parabolic drive. Traces 1040 and 1080 show the BER using an integrate-and-dump receiver.

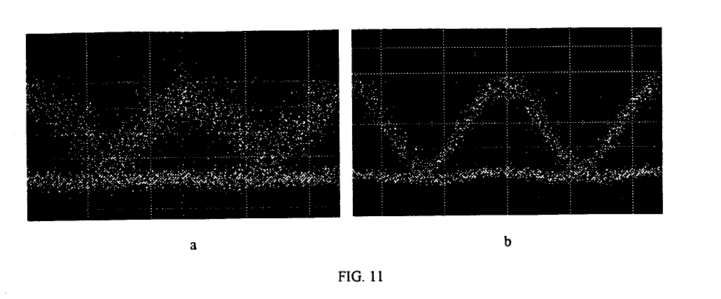

FIGS. 11a and 11b shows the eye diagrams at 7200 km of one channel of a dense WDM transmission at 10 Gbit/s per channel and 50 GHz channel separation, with orthogonally polarized adjacent channels, 11a being without jitter-killer and 11b being with jitter-killer driven by fundamental-second harmonic combination, and with pre-compression of the pulses.

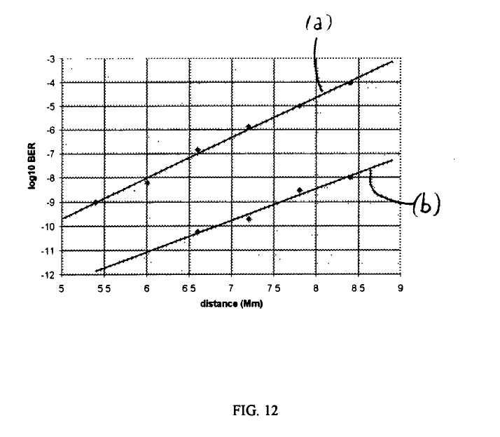

FIG. 12 shows the BER versus distance, both with and without the temporal lens jitter-killer of the present invention, (plots b and a respectively).

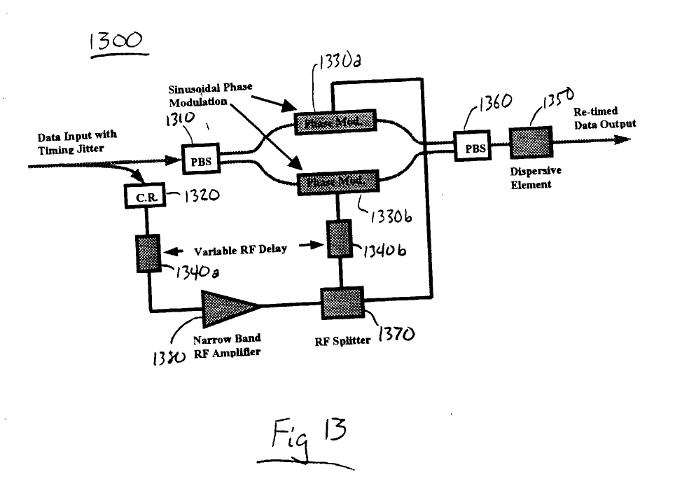

FIG. 13 illustrates a block diagram of another preferred embodiment of the temporal lens apparatus of the present invention. As shown in FIG. 13, the device comprises a first polarization beam splitter (PBS) 1310 which separates the data input signal of arbitrary polarization into two, orthogonal, linearly-polarized components. The components are then sent through phase modulators 1330a and 1330b respectively, which are driven in synchronism with a locally recovered clock signal. The output of the two phase modulators 1130a and 1330b are re-combined by a second PBS 1360 before being sent to a linearly dispersive element 1350. The phase modulators 1330a, 1330b gives each incoming pulse a frequency shift proportional to its jitter displacement, and the dispersive element 1350 serves to translate, or “focus” each incoming pulse onto the mean arrival time (modulo the bit period). Variable RF delay lines 1340a and 1340b are employed in the recovery to ensure that the sinusoidal drive voltage at the modulators 1330a, 1330b has the required phase with respect to the mean arrival time of the optical pulses. The narrow band RF amplifier 1380 increases the voltage of the sinusoidal drive to the level required for optimal focusing of the optical pulses at the device output (“Re-timed Data Output”). The RF splitter 1370 provides for equal amplitude drive for the two phase modulators 1330a-b.

It will be appreciated by those skilled in the art that changes can be made to the embodiments described above without departing from the broad inventive concept thereof. It is understood, therefore, that this invention is not limited to the particular embodiments disclosed, but is intended to cover modifications within the spirit and scope of the appended claims and their legal equivalents.

We claim:

1. A jitter compensator apparatus comprising:
a phase modulator for receiving jittered pulses; and
a clock recovery device for locally recovering a clock signal;
wherein the phase modulator is driven in synchronism by the locally recovered clock signal and is adapted to provide a frequency shift to the jittered pulses proportional to the jitter displacement of each of the jittered pulses.

2. The jitter compensator apparatus of claim 1, further comprising a linear dispersive element coupled to the phase modulator for focusing the frequency-shifted pulses to a common arrival time, modulo the bit period.

3. The jitter compensator apparatus of claim 2 wherein the linear dispersive element is a Bragg grating.

4. The jitter compensator apparatus of claim 1, further comprising means for adding second harmonic to the clock signal for improving the drive of the phase modulator such that the capature range is extended to about ±30% or more of the bit period.

5. The jitter compensator apparatus of claim 1, further comprising a pulse compressor for compressing the jittered pulses before being received by the phase modulator.

6. The jitter compensator apparatus of claim 5, wherein the pulse compressor includes highly non-linear, low dispersion fiber and a dispersive element.

7. The jitter compensator apparatus of claim 1, wherein the clock recovery device comprises an optical detector whose output is coupled to a phase-averaging apparatus, such that the output is a sinusoid of steady phase to represent the mean arrival times of the pulses.

8. The jitter compensator apparatus of claim 1, further comprising a drive phase adjustment device adapted to automatically adjust the phase of the clock signal driving the phase modulator.

9. A jitter compensator apparatus comprising:
a first polarization beam splitter for separating a jittered pulse signal into a first signal component and a second signal component;
a first phase modulator for receiving the first signal component;
a second phase modulator for receiving the second signal component;
a clock recovery device for locally recovering a clock signal; and
a second polarization beam splitter for combining output signals from the first and the second phase modulators,
wherein the first and second phase modulators are driven in synchronism by the locally recovered clock signal and are adapted to provide a frequency shift to jittered pulses of the jittered pulse signal proportional to the jitter displacement of each of the jittered pulses.

10. The jitter compensator apparatus of claim 9 further comprising a linear dispersive element coupled to the second polarization beam splitter for focusing the frequency-shifted pulses to a common arrival time, modulo the bit period.

11. The jitter compensator apparatus of claim 10 wherein the linear dispersive element is a Bragg grating.

12. The jitter compensator apparatus of claim 9, further comprising means for adding second harmonic to the clock signal for improving the drive of the phase modulator such that the capture range is extended about ±30% or more of the bit period.

13. The jitter compensator apparatus of claim 9 further comprising a pulse compressor for compressing the jittered pulses of the jittered pulse signal before being received by the first polarization beam splitter.

14. The jitter compensator apparatus of claim 13 wherein the pulse compressor includes highly non-linear, low dispersion fiber and a dispersive element.

15. The jitter compensator apparatus of claim 9, wherein the clock recovery device an optical detector whose output is coupled to a phase-averaging apparatus, such that the output is a sinusoid of steady phase to represent the mean arrival times of the pulses.

16. The jitter compensator apparatus of claim 9, further comprising a drive phase adjustment device adapted to automatically adjust the phase of the clock signal driving the phase modulator.

17. A method of compensating for jitter in an optical transmission system comprising:
using a phase modulator prior to a receiver to provide a frequency shift to jittered pulses of a jittered pulse signal, wherein the phase modulator is driven in synchronism with a locally recovered clock signal.

18. The method as claimed in claim 17 further comprising adding a second harmonic to the clock signal to improve the drive of the phase modulator such that the capture range is extended to about ±30% or more of the bit period.

19. The method as claimed in claim 17 further comprising compressing the jittered pulses before using the phase modulator.

20. The method as claimed in claim 17 further comprising automatically adjusting the phase of the clock signal driving the phase modulator.

21. A method of compensating for jitter in an optical transmission system comprising:
separating a jittered pulse signal into a first signal components and a second signal component; and
using a first phase modulator and a second phase modulator to provide a frequency shift to jittered pulses of the first signal component and the second signal component of the jittered pulse signal proportional to the jitter displacement of each of the jittered pulses;
wherein the first and second phase modulators are driven in synchronism by the locally recovered clock signal.

22. The method as claimed in claim 21 further comprising adding a second harmonic to the clock signal to improve the drive of the phase modulator such that the capture range is extended to about ±30% or more of the bit period.

23. The method as claimed in claim 21 further comprising compressing the jittered pulses of the jittered pulse signal before being received by the first polarization beam splitter.

24. The method as claimed in claim 21 further comprising automatically adjusting the phase of the clock signal driving the first and second phase modulators.

25. The method as claimed in claim 21 further comprising using a second polarization beam splitter to combine the output signals of the first and second phase modulators.

26. The method as claimed in claim 25 further comprising providing the output of the second polarization beam splitter to a linear dispersive element to focus the frequency-shifted pulses to a common arrival time, modulo the bit period.
